(19) United States
(12) Patent Application Publication
(10) Pub. No.: US 2014/0065591 A1
(43) Pub. Date: Mar. 6, 2014

(54) COLLABORATIVE LEARNING SYSTEM

(71) Applicants: Bruce Lorin Tulgan, Hamden, CT (US); Jeffrey Michael Coombs, Stamford, CT (US)

(72) Inventors: Bruce Lorin Tulgan, Hamden, CT (US); Jeffrey Michael Coombs, Stamford, CT (US)

(73) Assignee: RainmakerThinking, Inc., New Haven, CT (US)

(21) Appl. No.: 13/601,133

(22) Filed: Aug. 31, 2012

(51) Int. Cl. G09B 5/08

(52) U.S. Cl. 434/350

(57) ABSTRACT

In one aspect, in general, a system comprises a computer system configured to enable users to interact with a collection of learning groups, each learning group associated with at least one group leader and having members each approved by a group leader, and within each learning group, instances of training programs chosen by the group leader from a library of training programs available to the system, each instance of a training program includes a collection of lessons, each lesson includes a multimedia portion and an interactivity portion, the interactivity portion enabling asynchronous interaction among the members of the learning group, the multimedia portion being available to users other than members of the learning group, and the interactivity portion being available only to the members of the learning group

### TECHNICAL FIELD

This description relates to a collaborative learning system.

### BACKGROUND

Online systems can be used for educational purposes. For example, a system can enable one or more participants to log into the system and view educational media, such as text, graphics, audio, and video.

### SUMMARY

In one aspect, in general, a system comprises a computer system configured to enable users to interact with a collection of learning groups, each learning group associated with at least one group leader and having members each approved by a group leader, and within each learning group, instances of training programs chosen by the group leader from a library of training programs available to the system, each instance of a training program includes a collection of lessons, each lesson includes a multimedia portion and an interactivity portion, the interactivity portion enabling asynchronous interaction among the members of the learning group, the multimedia portion being available to users other than members of the learning group; and the interactivity portion being available only to the members of the learning group.

Implementations may include one or more of the following features. The training programs are automatically pushed via electronic notification to the respective members of a learning group on a schedule determined by and adjustable by the group leader of the learning group. The training programs included within a learning group can be each chosen by the group leader. The training programs can be accessed by any member in any order. The members of each learning group are enabled to invite other individuals to become members of the learning group. The multimedia portion of each lesson includes a video viewable by the members of the learning group. The interactivity portion of each lesson includes an online messageboard that enables the members of the learning group to hold asynchronous conversations about the multimedia portion. The group leaders are enabled to purchase training programs on a basis of a number of training programs and a number of members of a learning group associated with the respective group leader. The group leaders are enabled to purchase a subscription to the library of training programs available to the system, whereby the group leader can choose any training program to be used with the learning group associated with the respective group leader. The training programs can be purchased by the group leader on a ‘per program, per person in group’ basis, where the subscription never expires, and on a universal access basis, whereby each person in the group has access to all available training programs at a set, per year price. Each learning group can include one or more learning sub-groups, each learning sub-group having members selected from members of the learning group. The users are enabled to create training programs consisting of a sequenced series of lessons in text and/or video for delivery in the learning groups. The system further comprises a facility to provide automatic electronic notification to push each lesson of a particular training program to members of a learning group. The system further comprises a facility to provide the option for group leaders of automatically posting conversation starters, one for each lesson of a training program. The computer system enables users to access pages that allow each member of a learning group to keep track of all interactivity material composed by the respective member, regardless of program, within a particular learning group. The computer system enables users to access pages that provide a static list of each lesson of a training program.

In another aspect, in general, a collaborative learning system comprises a database of training programs, wherein a plurality of training programs include a plurality of lessons, wherein each lesson of the plurality of lessons comprises a multimedia portion and an interactive portion a processor configured to implement an access control system in which a plurality of group leaders are permitted to each assign participants to separate learning groups, and wherein learning group participants of one group do not have access to the interactive portions of other groups; and a web-based interface to allow access by participants to the system.

Implementations may include one or more of the following features. Lessons of the training programs are automatically pushed via electronic notification to the respective participants of a learning group on a schedule determined by and adjustable by the group leader of the learning group. The training programs included within a learning group can be each chosen by the group leader and can be accessed by any member in any order. The multimedia portion of each lesson includes a video viewable by the participants of the learning group, and the interactivity portion of each lesson includes an online messageboard that enables the participants of the learning group to hold asynchronous conversations about the multimedia portion.

Other features and advantages will become apparent from the following description, and from the claims.

### DESCRIPTION OF DRAWINGS

FIG. 1 shows a block diagram of a collaborative learning system.

FIGS. 2-8 show screenshots of interfaces for interacting with an example implementation of a collaborative learning system

FIG. 9 shows a block diagram of a computer system and related components.

FIG. 10 shows another block diagram of a collaborative learning system.

### DETAILED DESCRIPTION

A collaborative learning system can push via automated electronic notification a sequenced series of lessons to participants of a private learning group, with a private discussion, on a schedule adjustable by a group leader. The lessons can be multimedia lessons such as videos.

The collaborative learning system is provided to enhance the effectiveness of training in a variety of settings, including, for example, within corporate environments with many training participants. The content of the training may include, but is not limited to, academic, social, leadership, corporate practices training The system is well suited for training of content where there is no one right answer, and where the participants benefit from the group interaction.

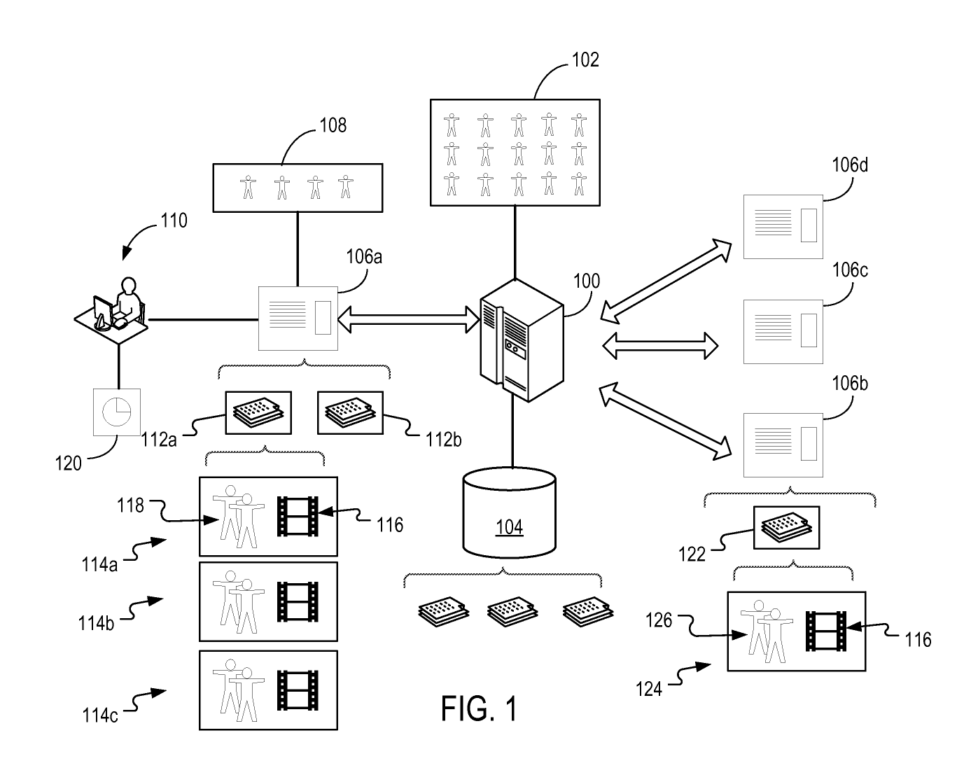

FIG. 1 shows a collaborative learning system 100 that enables users 102 of the collaborative learning system 100 to participate in learning experiences. For example, the users 102 can participate in training programs 104 offered by the collaborative learning system 100.

The collaborative learning system 100 may be a computer system configured to offer the training programs 104. For example, the collaborative learning system 100 can be a web server, and the training programs 104 may be data accessible to the web server. The training programs 104 could be stored on the web server, but they need not be. For example, they could be stored on a different server accessible to the collaborative learning system.

The collaborative learning system 100 provides users 102 access to the training programs 104 in the form of learning groups 106a-d. A learning group 106a is associated with a set of learning group participants 108, who are a subset of the users 102 of the collaborative learning system 100. Each of the learning group participants 108 is chosen by another learning group user or a learning group leader 110. For example, one of the learning group participants 108 or the learning group leader 110 can invite a person to the learning group 106a. If the person is not already one of the users 102 of the collaborative learning system 100, that person becomes one of the users 102 of the collaborative learning system 100 when she joins the learning group 106a.

The learning group 106a includes instances of training programs 112a, 112b. The instances of the training programs 112a, 112b are generated from the training programs 104 (e.g., generated from data making up the training programs 104) available to the collaborative learning system 100. The learning group leader 110 choses which training programs 104 to instantiate in the learning group 106a.

Each instance of a training program 112a, 112b is private to a single learning group 106a. Put another way, an instance of a training program 112a, 112b accessible to one learning group 106a is inaccessible to other learning groups 106b-d. If a user of the collaborative learning system 100 is not a learning group participant 108 of a learning group 106a, then that user cannot access the instances of a training program 112a, 112b available to the learning group 106a.

An instance of a training program 112a includes one or more lessons 114a-c. The number and content of the lessons 114a-c included in an instance of a training program 112a is determined by the corresponding training program 104 available to the collaborative learning system 100. Alternatively, the instance of a training program 112a may be a subset of the corresponding training program 104 available to the collaborative learning system 100, and the subset would depend on criteria corresponding to the group leader setting up the training program instance. For example, some group leaders may have access to enhanced training programs while others have access to standard training programs. Each lesson 114a-c includes a multimedia portion 116 and an interactivity portion 118. The interactivity portion allows asynchronous interaction among the participants. However, the multimedia portion may be interactive in the sense the user may interact with it. For example, a video will have typical start, stop, pause, rewind, fast forward controls. The video may have multiple paths with additional explanatory material should a participant choose a longer video with additional content.

The multimedia portion 116 could be, for example, a video segment (e.g., a video lecture), an audio segment (e.g., spoken word segment), an animation, or another kind of multimedia content or combination of any of these. A lesson 114a-c could also include tests, quizzes, or other evaluation (e.g., before or after the multimedia portion is accessed by a participant), as well as surveying or feedback facilities. The multimedia portion 116 of a lesson 114a is shared with a corresponding lesson in other instances of the training program. Put another way, the same multimedia portion 116 is reused every time an instance of a particular training program 104 available to the collaborative learning system 100 is generated for a learning group 106a-d. The collaborative learning system 100 can generate many instances of a training program 104 and the same multimedia content can be used with each instance, even though learning groups 106a-d do not share the same instance of a training program 112a.

The interactivity portion 118 could be, for example, an interactive message board, an instant messaging facility (e.g., a chat room), an exchange of e-mail messages, or another kind of interactive facility. The interactivity portion 118 enables the learning group participants 108 to engage in interactions relating to the corresponding lesson 114a. For example, the learning group 106a may provide an interface to a message board that can be used to discuss the corresponding lesson 114a. The learning group participants 108 can then post messages on the message board. The interactivity portion 118 need not be accessed by learning group participants 108 at the same time as the multimedia portion 116 is accessed by learning group participants 108. For example, the learning group participants 108 can each access the multimedia portion 116 and then post messages in the interactivity portion 118 at times chosen by each participant. Some learning group participants 108 may post messages about the lesson 114a immediately after accessing the multimedia portion 116, while other learning group participants 108 may return to the interactivity portion 118 at a later time (perhaps after accessing other multimedia portions of other lessons) to participate in discussion. In this way, the interactivity portion 118 enables interaction among the learning group participants 108 that is asynchronous in its own right, and also with respect to the multimedia portion 116.

Another learning group 106b may have an instance of a training program 122 generated from the same training program as an instance of the training program 112a in the first learning group 106a. For example, this instance of a training program 122 may have a lesson 124 containing the same multimedia portion 116 as a lesson 114a of the instance of the training program 112a in the first learning group 106a, but the lesson 124 also has a different interactivity portion 126 that is only accessible by participants of this learning group 112. Interactivity portions are not shared among different instances of a training program.

In some examples, the lessons 114a-c share a single facility that makes up the interactivity portions 118 of each lesson. For example, the learning group 106a may have a single interactive message board, and the message board may have forums for each instance of a training program 112a, 112b and sub-forums within each forum for each lesson 114a-c.

The lessons 114a-c are “pushed” to the learning group participants 108 on a schedule 120 chosen by and adjustable by the learning group leader 110. For example, the learning group 106a can communicate to each learning group participant 108 that a particular lesson 114a is available. In some implementations, the collaborative learning system 100 sends automated messages to the learning group participants 108 indicating a timeframe during which to access the lesson 114a. In this way, the learning group participants 108 can access lessons 114a-c based on the schedule 120 chosen by the learning group leader 110. The learning group 106a need not control access to the lessons 114a-c based on the schedule 120. For example, some or all of the learning group participants 108 may be allowed to access lessons 114a-c on a schedule different than the schedule suggested to them by the learning group 106a-c (e.g., as suggested by automated messages sent by the learning group 106a-c). In addition, a participant may choose to view lessons 114a-c out of order and wholly independent from any established schedule.

The participant may also access the discussion board of past lessons, review comments by others and add additional comments. Typically, learning group participants 108 access lessons 114a-c at times that align with the schedule 120, and the learning group participants 108 can engage in discussion (e.g., using the interactivity portions 118 of lessons 114a-c) in the same time frame as each other.

In general, the collaborative learning system 100 (sometimes called simply “the system”) is capable of the following:

1) A learning group leader 110 (also known as simply a group leader) may form a learning group 106a that is private to the learning group participants 108. The learning group leader 110 can determine who is in the learning group 106a initially, may add anyone to the learning group 106a any time, and may remove anyone from the learning group 106a any time.

2) With the exception of single user learning group 106a (where there is only one person in the group), learning group participants 108 are invited by someone they know to become a member of the learning group 106a (i.e., a learning group participant 108). In some implementations, there are no ‘public access’ learning groups (i.e., learning groups open to any user of the collaborative learning system 100 to join at any time).

3) Learning group participants 108 receive one or more instances of training programs 112a, 112b, chosen by the learning group leader 110. Each training program is arranged in a series of lessons 114a-c designed to be delivered in sequence, although the system allows for deviations from that sequence.

4) The training programs can be purchased by the learning group leader 110 in the form of subscriptions. For example, there could be two types of subscriptions—(a) purchased on a “per program, per person in group” basis, where the subscription never expires, and (b) “universal access,” where each person in the group has access to all available training programs at a set, per year price. Other options may also be available, such as subscriptions permitting a limited number of programs to be active at any one time over the subscription period.

5) The lessons 114a-c are “delivered” on any schedule, as determined by and adjustable by the learning group leader 110. Because learning group participants 108 have training content pushed to them on a continuous basis, their online conversations are generally about those lessons.

6) For training programs 104 that the learning group leader 110 has purchased, all lessons are available to learning group participants 108 at all times (i.e., learning group participants 108 can work out of sequence any time they like).

7) As one example of an implementation, a lesson 114a-c within an instance of a training program 112a, 112b can consist of (a) a short video, average length=3 minutes, and (b) a message board that facilitate social-network style (but private) conversations within the learning groups.

8) In this example, learning group participants 108 may comment on each lesson 114a-c and may comment on each other's comments; the comments may be made in text or by posting a video; only other members of the group may see the secure private online conversation among the group; the comments are archived for ongoing review and conversation by members of the secure private group.

While each training program is arranged in a sequenced series of lessons, designed to be delivered in sequence, the learning group leader 110 and learning group participants 108 can do the lessons in any order he/she chooses. The learning group leader can send notice of new lessons on any schedule he/she chooses. The schedule can be regular or irregular and it can change any time. The learning group leader can repeat any lesson any time; can repeat the whole sequence of lessons any time, at any pace. Learning group participants can also repeat any lesson. The learning group leader can send notice of any lesson any time to the learning group participants. The learning group leader can send notice of any lesson any time to any subset of the learning group participants.

The learning group leader can choose for the group from several notification options, and notifications may be via email, SMS, instant messaging, or other available notification technology. For example, the learning group participants can be notified only when a new/next lesson is posted. Learning group participants can be notified when leader makes a comment. Learning group participants can be notified any time anyone in the group makes a comment.

The collaborative learning system 100 can make a large number (e.g., hundreds or thousands or more) of training programs 104 available. The collaborative learning system 100 can also enable users 102 to create their own training programs 104 consisting of a sequenced series of lessons in text and/or video for delivery through the collaborative learning system 100. The training lessons may be created independently of lessons already loaded in the system, or alternately a user (such as a learning group leader) can customize training programs by assembling from content currently available on the collaborative learning system.

A learning group 106a-c can be of any size (e.g., have any number of participants). In some implementations, one or more learning groups may be formed within a learning group. For example, one learning group 106b may be formed within another learning group 106a. As an example, “company A” has 1000 members of a learning group 106a subscribed to “training program #1.” Within that learning group 106a, other learning groups could be formed to take training program #1 together. That means any individual could be a participant of a larger learning group 106a, as well as a participant of the learning groups within the larger learning group 106a, taking training program #1 in various configurations. For example, some of the smaller learning groups could each have its own instance of training program #1. Privacy controls can allow for each learning group to be private and not accessible from other learning groups, or participants in the top level learning group may be provided access to all or a portion of the subgroups established within the larger learning group.

The use of content can be flexible. For example, A learning group can make just one training program available, or as many different programs as are available on the collaborative learning system 100, or any number in between. Further, a learning group can have multiple instances of the same training program (e.g., each with its own interactivity portion). Each instance could be formed within a smaller learning group within the larger learning group, but this need not be the case. A large learning group could subscribe to multiple training programs. The collaborative learning system 100 could offer a “universal pass” so that a learning group has access to all training program 104 available on the collaborative learning system 100.

As an example, “company A” may have 1000 members of a learning group subscribed to training programs #1, #2, and #3 OR “universal.” Smaller groups could be formed to make available any one of those programs or any number of those programs in various configurations. An individual user 102 could be part of multiple learning groups doing various programs.

A learning group leader 110 can, among other things, choose who is in the corresponding learning group, add participants, drop participants, choose what training program(s) will be the content for the learning group, determine a schedule 120 for sending what lessons when and to whom, and determine what notifications a participant will get.

Learning group participants 108 learn in a learning group 106a chosen by the corresponding learning group leader 110. The collaborative learning system 100 may enable learning group participants 108 to engage in a variety of activities. Some implementations enable learning group participants 108 to, among other things, have access to and receive lessons from programs chosen and purchased by the learning group leader, receive notice of lessons on a schedule set and managed by the learning group leader, receive notifications of lessons and comments, as determined by the group leader, have access to lessons of purchased training as they are sent by group leader and also to all lessons at any time that they choose, watch/read lessons of purchased programs any time, an unlimited number of times, comment on lessons any time, an unlimited number of times, in text and/or video, and/or comment on any comment of another member of secure private learning group, an unlimited number of times, in text and/or video.

A learning group 106a may include an archive of interactivity portions 118 of lessons. For example, group conversations can be archived and made available to the learning group arranged by program, and /or by lesson within each program. Some implementations may have a running chronological log of the ongoing conversation on all lessons and programs among the participants of the learning group. Others may have more sophisticated options allowing participants to set customized and personal criteria for accessing the interactive content, such as limiting the display to recent comments, threads with recent postings, or filter the conversation to include or exclude comments from specific participants. The system can also provide for keyword and full text search of comments. In some implementations, the system has a context engine to organize comments by content. For example, a participant may be able to choose to view comments from a menu of available contextual threads, which each thread relates to a specific aspect of the lesson plan.

Each time a learning group leader 110 purchases subscriptions to a training program 104, the lessons of the training program 104 need not be manually added to the learning group 106a. Instead, the learning group leader 110 can select a training program among the available training programs 104, and the chosen training program is automatically instantiated in the learning group 106a, with the multimedia content 116 of each lesson 114a-c automatically made available in the learning group 106a.

Learning group leaders 110 can be provided with the service of signing up learning group participants 108 as new users 102 of the collaborative learning system 100, and adding them to the appropriate learning group 106a. Learning group leaders 110 can also utilize a list of “conversation starters,” e.g., one for each lesson of a training program. The conversation starters can be set up to post on an automated, scheduled basis and can help lead the online conversation down the path of discussing the lesson in a meaningful, helpful way.

In some implementations, a web page can “hang” off of another web page representing the learning group 106a. A page that “hangs” is not part of the standard offering of collaborative learning system 100 but can be added by the system administrator as a customization option. For example, a “hanging” page could be a page that allows each learning participant to keep track of all his/her comments, regardless of program, within a particular learning group, e.g., a personal history of comments within that group. Other examples could include discussion forum entries on latest activity, newest discussions, most popular, featured, or group administrative discussions.

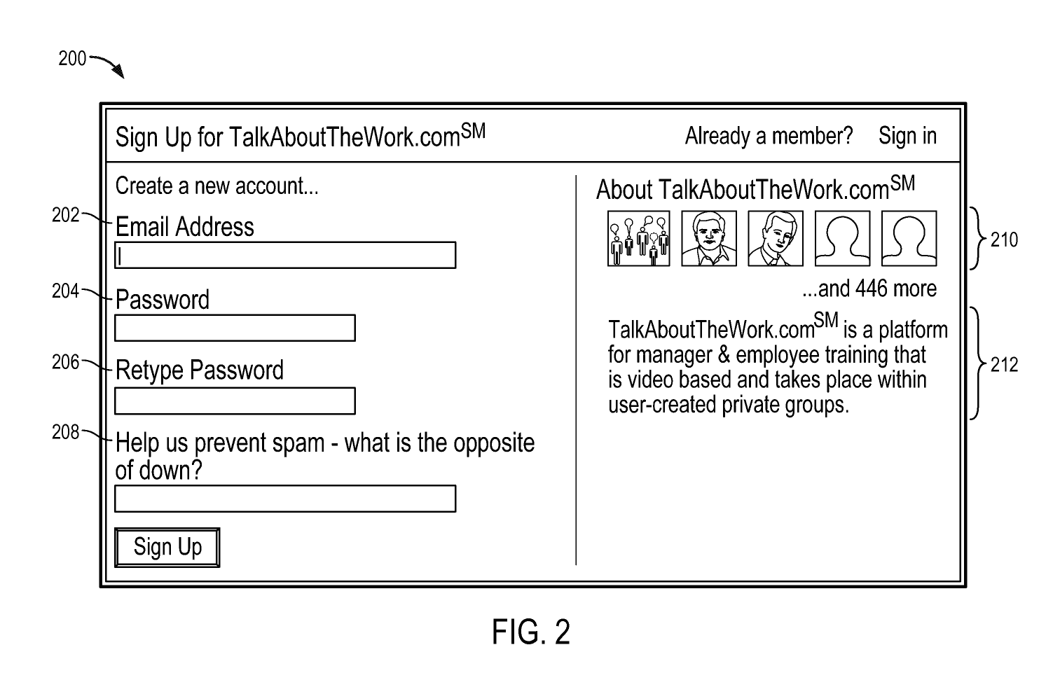

FIGS. 2-8 show example screenshots of interaction with one implementation of the collaborative learning system 100. This is only an example implementation, and interaction with the collaborative learning system 100 could take other forms in other implementations not detailed here. The examples shown use a system called Ning available from Ning, Inc. of Brisbane, Calif. However, for a more robust system, the collaborative learning system 100 could be implemented using other systems, including proprietary systems developed as implementations of the collaborative learning system 100. When a proprietary system is used, the activities that are described in the following examples can either be fully automated or controlled by the group leader.

FIG. 2 shows an interface 200 a learning group leader who wants to lead training for a group of multiple co-workers and colleagues could use to establish a learning group. In this example, the learning group leader signs up as a new user of the collaborative learning system. Each user of the collaborative learning system indicates a unique email address 202. Each user selects a password 204 and retypes 206 it. The system may provide a spam prevention question 208. Pictures 210 of a few users of the system and a short description 212 of the system is shown.

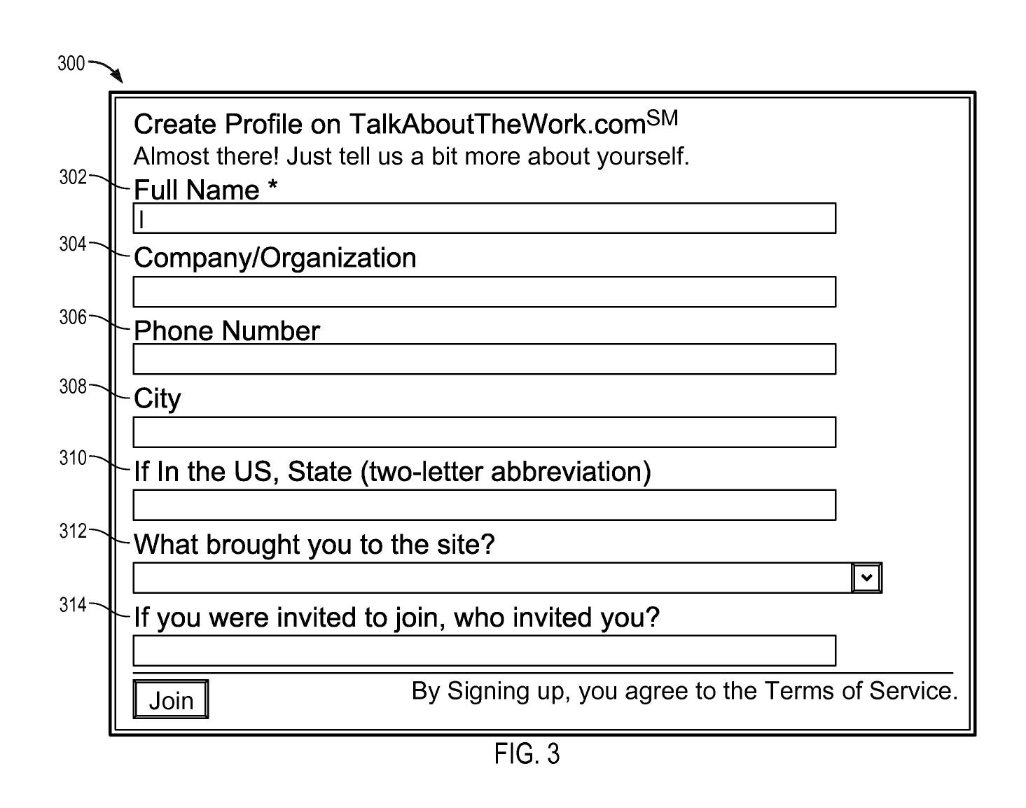

FIG. 3 shows an interface 300 for establishing a membership on the system. A new user can enter information including Full Name 302, Company 304, Phone Number 306, City 308, and State 310: A learning group question 312 has four options: 1) You are interested in training for a group of employees from your company; 2) You are interested in training for yourself (not as part of a group); 3) An existing member of the site invited you to join his/her learning group; 4) You are interested in the training but aren't sure what to do next. A “who invited you” question 314 can help a system administrator direct the person to the correct learning group.

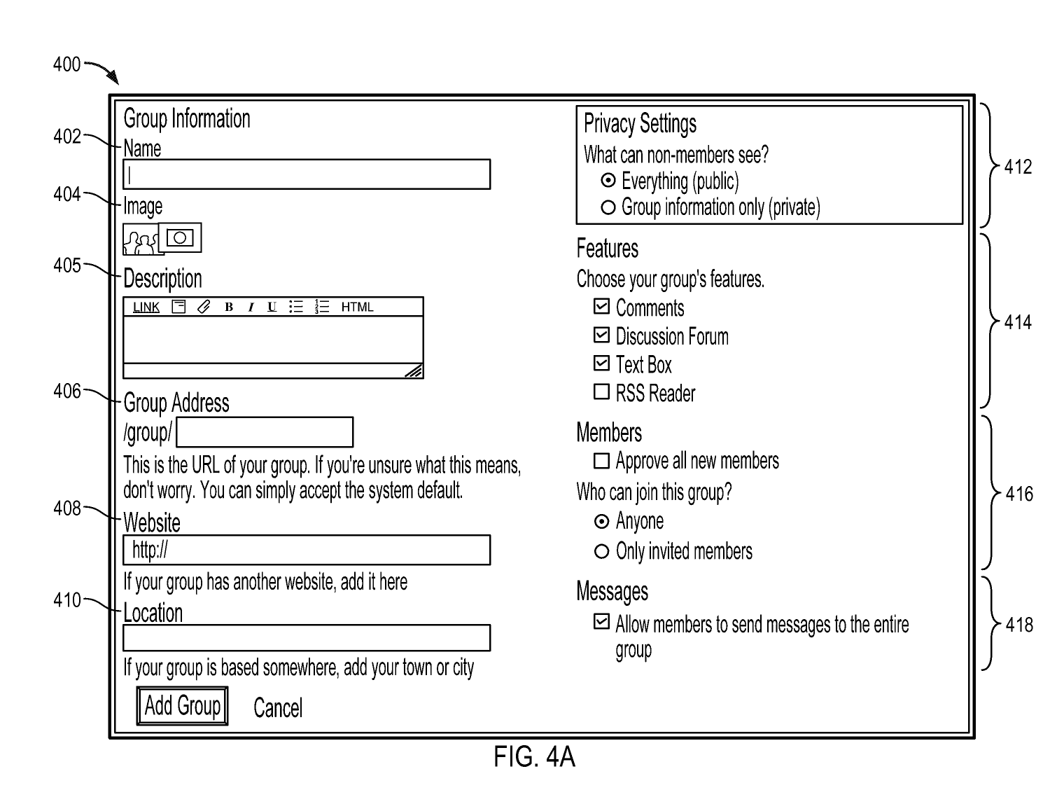

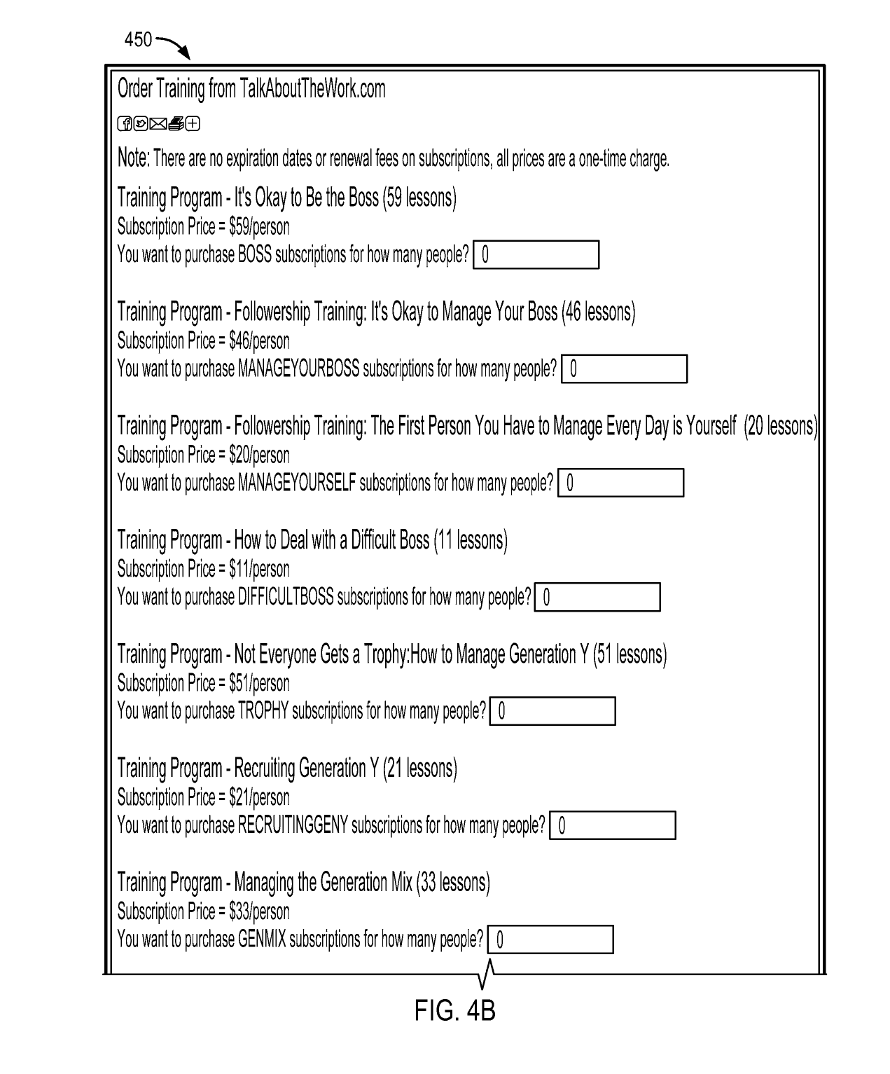

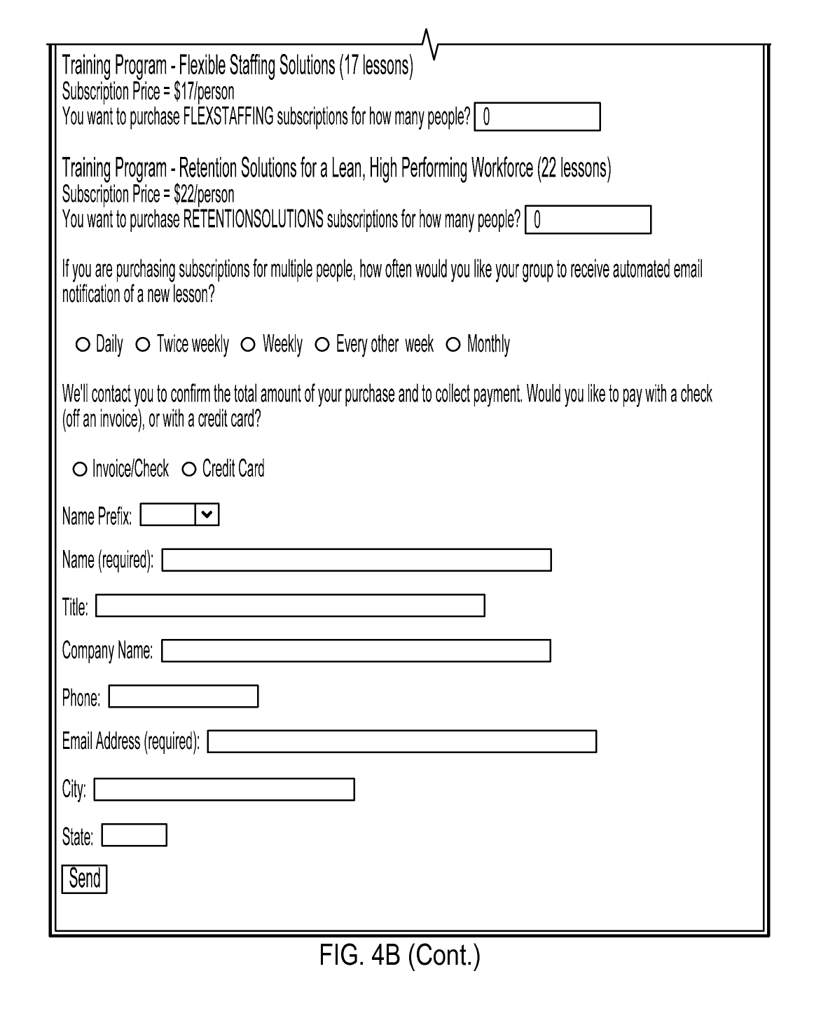

FIG. 4A shows an interface 400 a group leader can use to creates/starts a private learning group. The group leader can indicate the following items. The name 402 of the private learning group. An image 404 can be uploaded to help identify the group, for example, a corporate logo. A description 405 of the group can be provided. A group address 406 identifies the main directory that all “Discussion Forum” entries (ie, program lessons) and “pages” reside in for this particular group. Non-members of a group cannot see any information that resides in this directory or any sub-directories. A website 408 can be indicated, for informational purposes only, if user wants to identify a corporate or personal website. For informational purposes only, a user can identify a physical location 410. Privacy settings 412 are always set to “Group information only (private).” If user does not set this at “private” when the group is created, a system administrator changes it for him/her. Among features options 414, the only box checked is “Discussion Forum.” This allows a system administrator to post Discussion Forum entries, also known as training program lessons. If user checks any other boxes when the group is created, system administrator unchecks those boxes for him/her.

Among members options 416, “Approve all new members” always checked, indicates that a system administrator approves all new members. Subscriptions are priced on a per-user basis, so that the system administrator knows when a new user joins a group and needs to be charged for a subscription (or subscriptions). Also, “Only invited members” always checked, which prevents system members from randomly trying to join groups (ie, they can't even try to join a group unless they are electronically “invited”). The messages option 418 can be checked or unchecked. If checked, members of this group can send messages via the system to other group members.

In some examples, a learning group leader uses an online order form to purchase training program(s). FIG. 4B shows an example interface 450 describing the training programs.

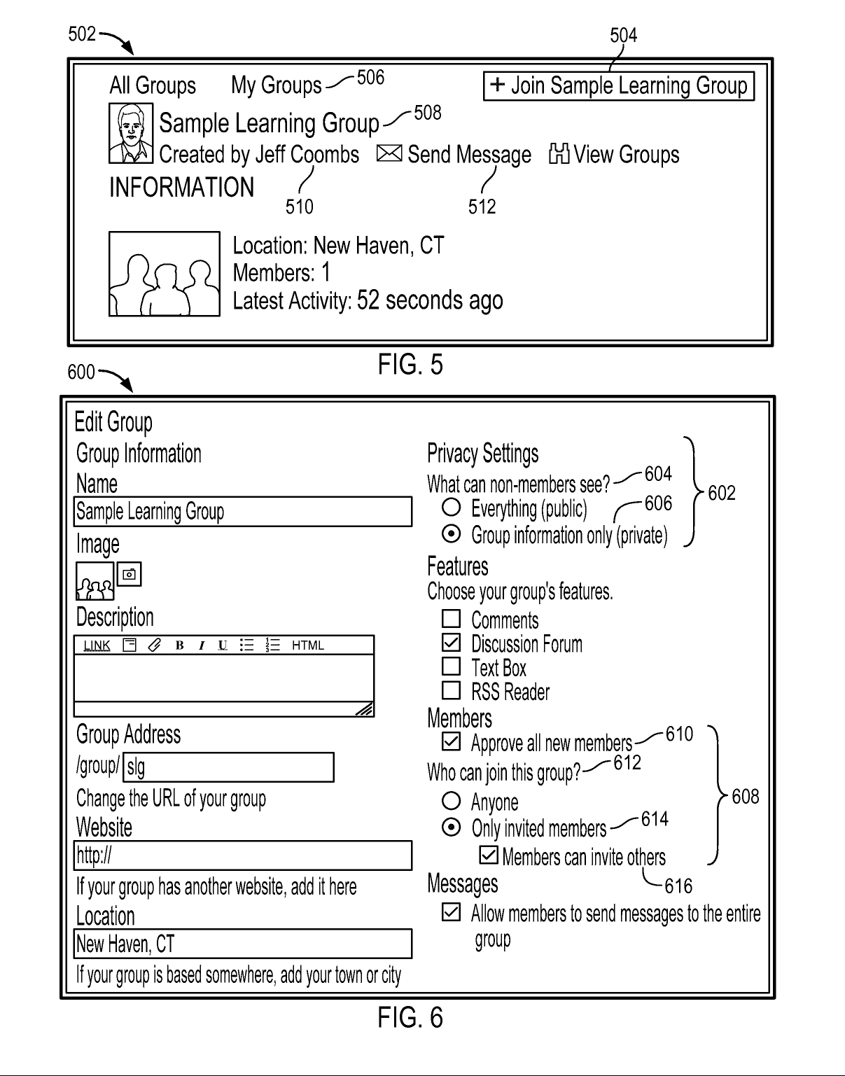

In some examples, a system administrator signs up all new members of the system (using same sign up screens shown in FIGS. 1 and 2) and adds each new member to the new private learning group created as shown in FIG. 3. FIG. 5 shows an interface 500 for adding a member to the new private learning group, which includes two steps, clicking on “All Groups” 502 and clicking on “Join ______ Group” 504 (in this example, “SRK Test Group,”).

As shown in FIG. 5, the interface 500 has options that include All Groups 502, which displays private learning groups available on the system; My Groups 506, which displays private learning groups on the system that the user is a member of; the name 508 of the group; the creator 510 of the group; and a send message 512 button that allows the user to send a message via the system to all other group members.

FIG. 6 shows an interface 600 that allows a system administrator to modify security settings for a learning group. Under “Privacy Settings” 602, options available are What can non-members see? 604 which is set to Group information only (private) 606. Under “Members” 608, options available are Approve all new members 610, which is enabled, and Who can join this group? 612, which is set to Only invited members 614 and Members can invite others 616.

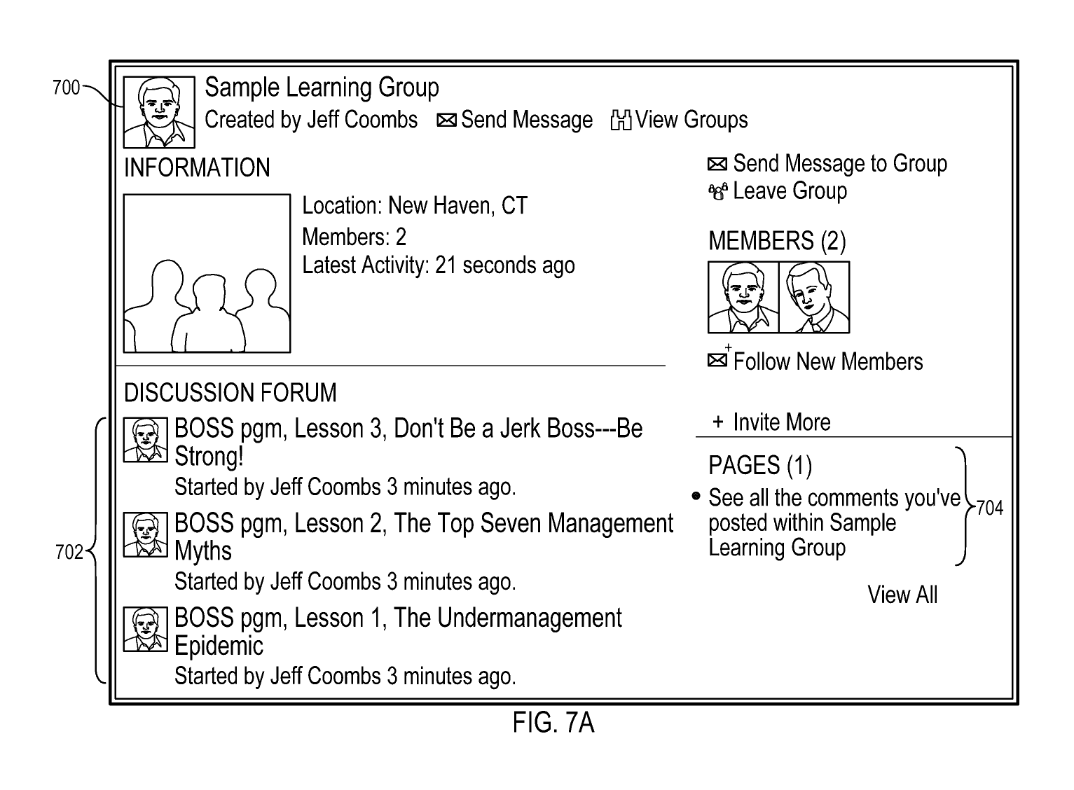

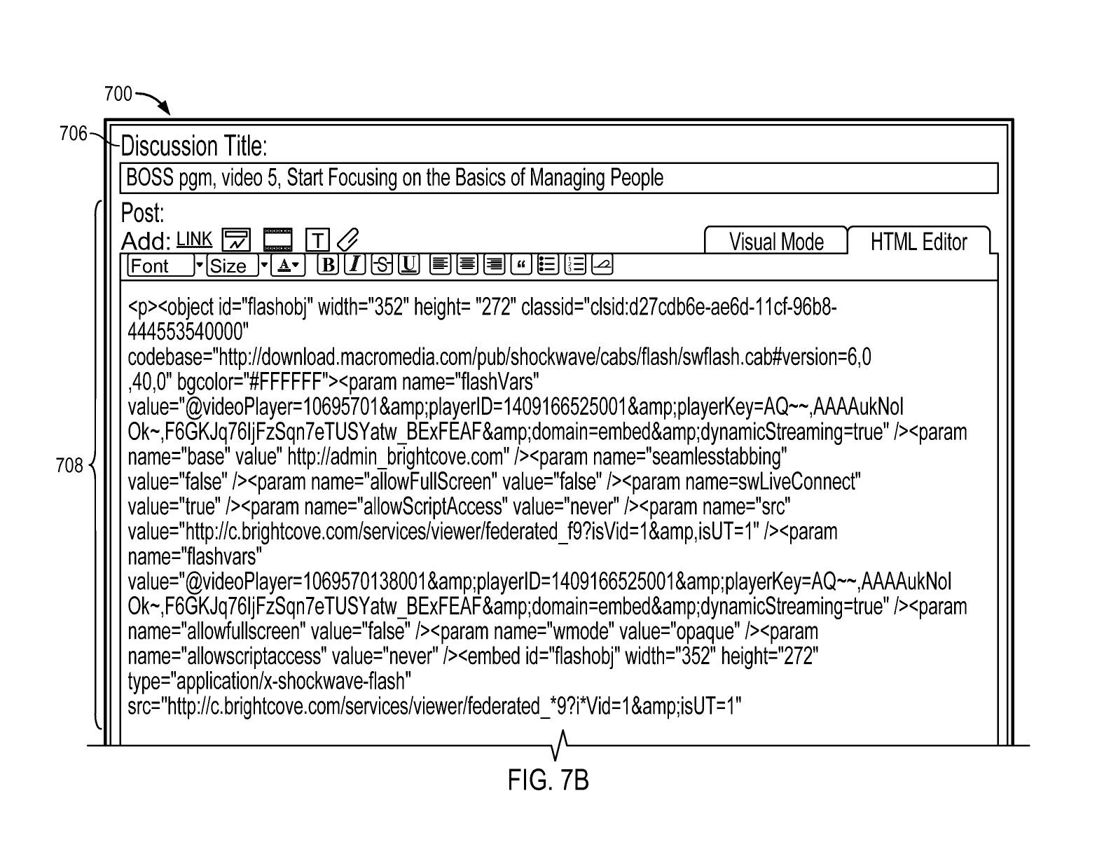

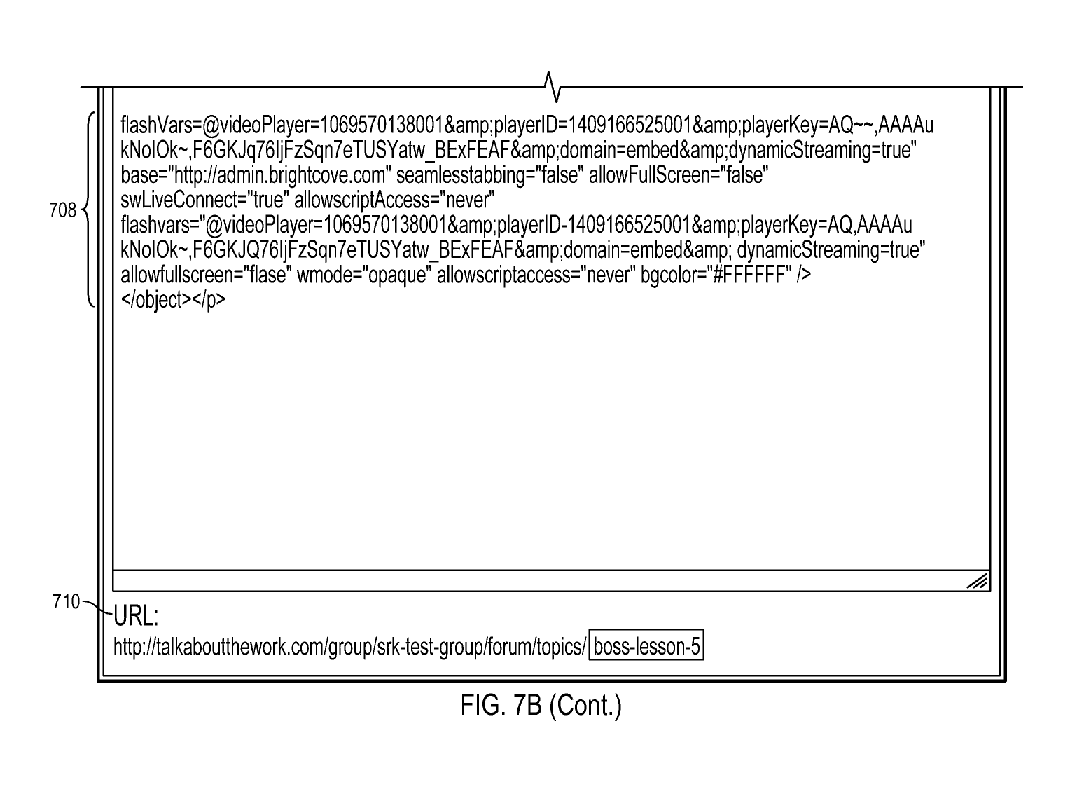

FIG. 7A and 7B show another view 700 of the interface 500 shown in FIG. 5. In this view 700, the system administrator has added all lessons for a training program to the private learning group. For example, this can be done via the “Discussion Forum” 702 on the group page.

Each entry in the Discussion Forum 702 is a different training program lesson. The system administrator adds program lessons to the group after group leader purchases a subscription to program. In the ‘Discussion Forum’ section, the program lessons are listed in order by ‘Latest Activity.” Pages 704 allows for the creation of custom “pages” by the system administrator for each learning group. Custom pages can include a spot for an individual user to see all the comments he/she has posted within the private learning group, and/or if a private learning group has multiple training programs, separate pages for each program, with a static list of links to each program lesson. A Discussion Title 706 can be added by system administrator, e.g., the name of the program lesson. The post 708 data is added by system administrator; this is HTML code for accessing the video for this particular program lesson. A URL 710 for this particular program lesson can be indicated; most of the URL is system generated, to guarantee group security/privacy.

At this stage, the system administrator sends the group leader a customized email template that he/she can broadcast to the group. The email contains a quick introduction/welcome the system; a notice of addition to private learning group; and instructions for changing system password. Then, for the training program(s) purchased, the system administrator communicates with the group leader to establish the schedule for automated lesson electronic notifications. The schedule is always adjustable by the group leader, via communication with the system administrator. Before the first automated electronic lesson notification is sent to the group, the system administrator (or group leader, if he/she chooses) posts a ‘conversation starter’ for the first lesson. Most group leaders prefer to have the conversation starters automatically posted for them, while a few group leaders prefer to post the conversation starters themselves. A list of conversation starters, one for each lesson in the program purchased, can be provided by system administrator.

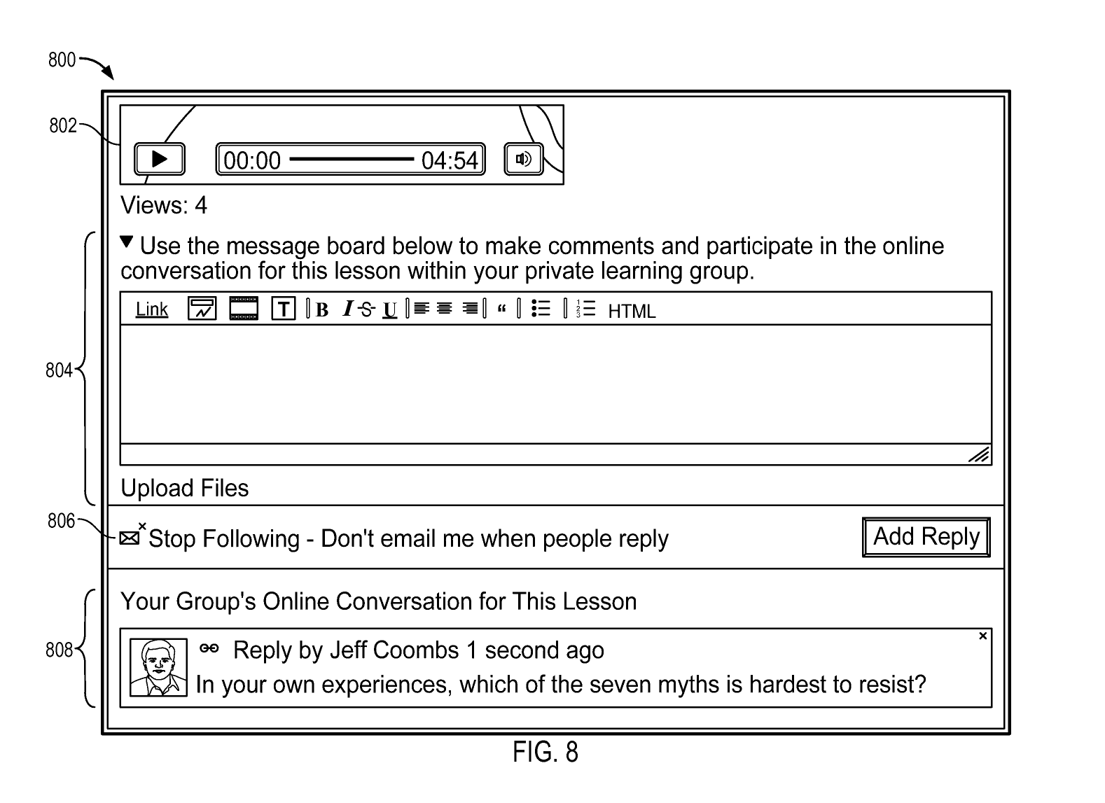

FIG. 8 shows an interface 800 for accessing a program lesson; system members may spend the large majority of their system time on screens like this. A user can see a video 802 (the bottom half is shown here). For each lesson, group members watch a video, average length=2 to 5 minutes. The interface 800 also includes a message board 804. A user can start his/her own message string. The interface 800 also provides a Stop Following option 806. By default, all group members are emailed when a new message is posted. User can click ‘Stop Following’ if he/she no longer wants to receive emails like that for this particular lesson. The interface 800 also includes a Your Group's Online Conversation for This Lesson section 808. In this section, the group's asynchronous online conversation is displayed. In this section, the user can reply to a message that has already been posted. The group leader can choose to have broadcast email sent n an automated basis to the group on whatever schedule he/she wants (e.g., once a week, twice a week, Tuesday this week and Wed/Thurs next week, etc.).

In some examples, a single user may want to purchase training for himself/herself, and is uninterested for now in training with a group. This arrangement is sometimes known as a “1-person private learning group.” The user can use the same interfaces as shown in FIGS. 2-8. Because there is no “conversation” within a 1-person learning group, a message board need not be established. After the 1-person private learning group is set up, the system administrator speaks with the single user to provide brief instructions and answer any questions before the single user begins his/her self-paced training program. Alternatively, a message board can be established for a 1-person learning group in which the message board effectively acts as a note archive for later reference.

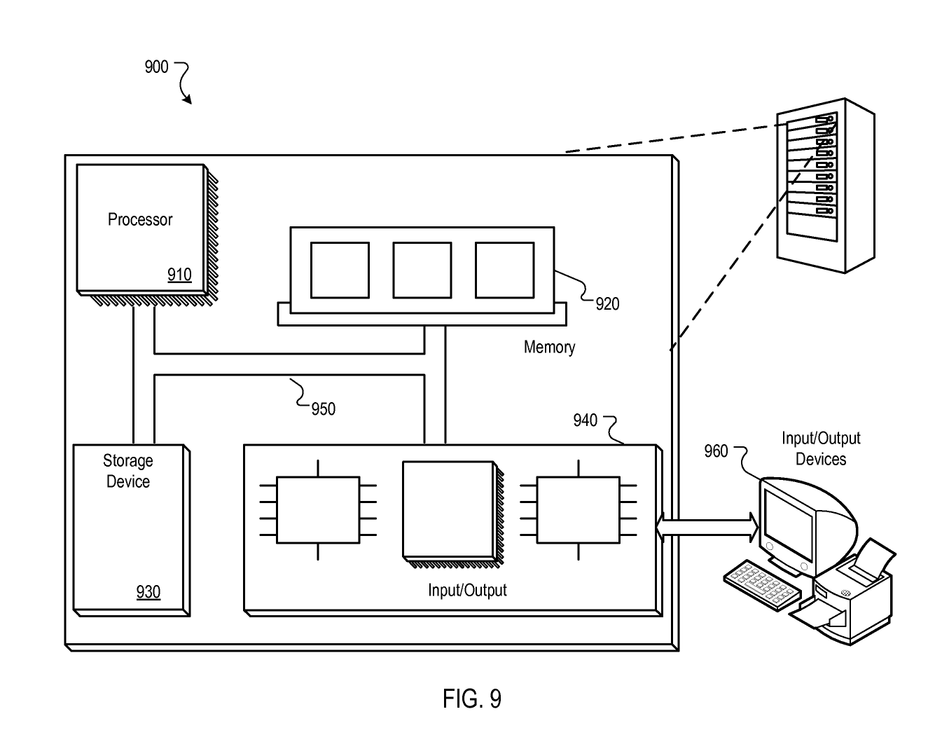

FIG. 9 is a block diagram of an example computer system 900. For example, the system 900 could be a system or a portion of a system implementing the collaborative learning system 100 shown in FIG. 1. The system 900 includes a processor 910, a memory 920, a storage device 930, and an input/output device 940. Each of the components 910, 920, 930, and 940 can be interconnected, for example, using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 can include, for example, a hard disk device, solid-state memory such as flash memory, an optical disk device, or some other large capacity storage device.

The input/output device 940 provides input/output operations for the system 900. In one implementation, the input/output device 940 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 960. Other implementations, however, can also be used, such as mobile computing devices, mobile communication devices, set-top box television client devices, etc. The mobile computing device, such as a tablet or smartphone, may be wirelessly connected to the system, or may be relayed through an intermediate device which appears to the system as the input/output device.

In some implementations, the system is provided using off-the-shelf web-based hosted software such as NING. In other implementations, the system is uses custom applications custom running on web server software as is known in the art to provide enhancements not available through hosted web-based software such as NING.

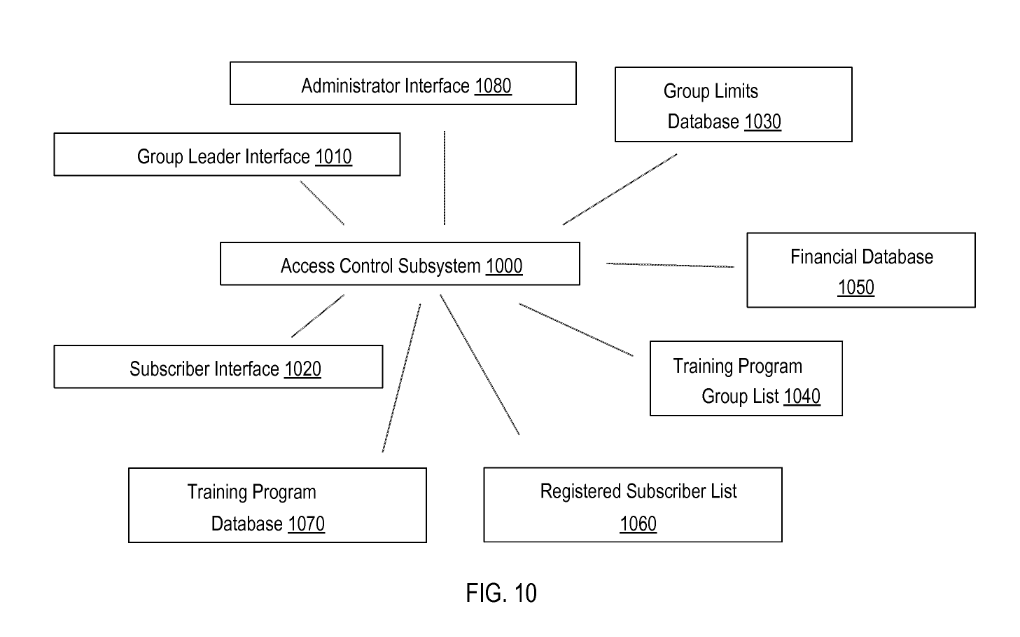

In another implementation, a computer system is divided into functional blocks. Referring to FIG. 10, an access control subsystem 1000 controls access from group leader interface 1010 and subscriber interface 1020. The access control subsystem interfaces to a database of group limits 1030 (what is this? JC) and based on the contents of that database allows the group leader to populate a training program group list 1040 from the registered subscriber list 1060 for the training system. The group limits database 1030 (why would we want this? JC) may limit the number of subscribers a group leader may specify for the group list 1040.

Alternatively, the access control subsystem may access the financial database 1050 and limit access based on the information contained there, including the amount paid for the training program. For example, a particular group leader may have unlimited access to all training programs, access to a subset of training programs, which may be organized into different topics or price levels, or access to a training programs so long as sufficient credits are in the group leader's account or in the account set up on behalf of the group leader (such as by the group leader's company).

The administrator accesses the system through the administrator interface 1080 which the administrator is directed to after entering administrator credentials. The system is well suited to be run and managed by a training company that is independent of the companies affiliated with the group leaders who control participation to individual learning groups.

In some examples, to maintain corporate confidentiality, each corporate participant would have its own secure area within the system that would be private to that corporation and which could not be accessed by individuals from other organizations. Each corporate participant can be provided with access to all learning groups within that organization. In other words, although each learning group is private, one or more representatives of the organization can be provided access to all groups. For example, the system may add each such representative to each learning group established by any group leader of the organization. The name of such representative may appear on the user list, or the system may optionally hide the name of such representative.

A subscriber is also granted access via the access control subsystem 1000 to the subscriber list 1060 to update the information provided for that individual subscriber. The access control subsystem 1000 also permits new subscribers to be added to the registered subscriber list via either the group leader interface 1010 or the subscriber interface 1020. The group leader interface 1010 and the subscriber interface 1020 are presented as interactive web pages providing the respective user with a specific set of tools and options depending on the type of interface.

The subscriber interface 1020 also permits non-registered users to view sample content, such as sample training videos or even complete or partial sample training programs. As shown, the sample content is controlled via the access control subsystem 1000, which can track statistics about the access to sample content for improving the degree non-subscribers of the system are converted to subscribers. However, this content may also be directly accessible to the subscriber interface 1020 in a simplified version of the training system. Non-subscribers access to the sample content may be tracked via requiring the non-subscriber to provide uniquely identifiable information or by placing accessible information on the non-subscriber's computer, such as a cookie.

In some examples, the group leader would typically initiate discussions on a topic and encourage participation by group members who are less participatory than others. The group leader would also have access to reports concerning member participation in the training program database 1070. The reports are generated based on status information stored within the program database. Such information may include when and for how long a member accesses a particular lesson, views a particular training video, and accesses personal and group learning spaces. Such information also includes the statistics and summary information about each members' use of the system, such as how many comments are made concerning a particular lesson and the amount of activity of each member over time.

In some implementations, the system has personal storage for each participant. Participants can store comments and notes in the personal notes area that is not accessible to other participants in the learning group. The system permits copying of data between the interactive portion and the personal notes area. The system permits group leaders to have access to the personal notes area of the participants in their respective groups and may also leave messages to participants through the personal notes area.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on a computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g. LCD (liquid crystal display) monitor, for displaying information to the user and a touchscreen, keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1-20. (canceled)

21. A training system comprising:
a database configured to store client information from a plurality of clients, each client comprising one or more individuals, and wherein the client information includes financial information used to charge clients for access to the training system,
a database configured to associate the individuals with different learning groups,
a storage area configured to store a plurality multimedia presentations,
a storage area configured to store interactive information associated with each multimedia presentations, the multimedia presentations and associated interactive information together form instances of training programs,
a computer system configured to permit a host administrator to provide customizable access controls to group leaders to permit the group leader to provide individuals customizable levels of access to training programs.

22. The training system of claim 21 wherein the training programs comprise the multimedia presentations organized in a default predetermined order, and where individuals may access the multimedia presentations and associated interactive information out of order.

23. The training system of claim 21, wherein the computer system is configured to provide a customizable schedule for delivery of lessons within a training program which is settable by the host administrator or group leader, and
wherein the computer system is configured to send automatic electronic notifications of lessons to individuals of a selected learning group according to the schedule.

24. The training system of claim 23, wherein the computer system permits a client representative identified by the client to access training programs that have been subscribed to by group leaders associated with the client, and wherein the computer system is configured to permit the client representative accessing a training program to be hidden from members of the learning group or alternatively identified as a member of the learning group.

25. The training system of claim 23, wherein the computer system is configured to permit clients to access certain training programs without charge, and is further configured to require payment for access to other training programs.

26. The training system of claim 25 wherein the computer system is configured to determine a fee for a training program in part based on how many individuals will be permitted to access the training program by the client.

27. The training system of claim 25, wherein the computer system is configured to permit group leaders to choose between access to a training program for a limited time or for an unlimited time.

28. The training system of claim 25, further including a group limit database and wherein the computer system limits a group leader's ability to associate individuals with learning groups based upon contents of the group limit database.

29. The training system of claim 22, wherein the computer system is configured to permit individuals from multiple clients to access same instance of a training program, and wherein individuals within a learning group are permitted to invite other individuals to join the learning group.

30. The training system of claim 21, wherein the computer system is configured to generate reports for group leaders based on activity in individual training programs, including an amount of time individuals have spent accessing the training program.

31. The training system of claim 21, wherein the computer system is configured to permit the host administrator to provide content to an interactive portion of the training programs to facilitate conversations within the training programs.

32. The training system of claim 21, wherein the computer system is configured to alert the host administrator when a posting is made to an interactive portion of a training program.

33. The training system of claim 21, further comprising:
an access control subsystem to control access by individuals to the training system;
an administrator interface providing a host administrator access to features not accessible to group leaders or individuals;
a group limits database which is accessed to limit a size of learning groups or the access to training programs by learning groups; and
a financial database which provides information about the access provided to group leaders to the training system.

34. A training system comprising:
means for providing a plurality of training programs to a plurality of independent entities on a subscription basis, wherein the entities will be charged based upon a number of training programs accessed, a number of individuals in a learning group, and an amount of time the training program will be accessible, and wherein a training program comprises a multimedia presentation portion and an interactive portion;
means for facilitating interactive learning by organizing a plurality of learning groups, wherein each learning group has a group leader, and wherein the group leader may select from a predefined set of conversation starters which will be provided to at least some individuals in a learning group; and
means for providing reports to group leaders concerning activity of the individuals in the respective learning groups.

35. A method of providing training comprising:
providing a plurality of training programs accessible over a network, each comprising a plurality of multimedia presentation portions and associated interactive portions wherein multimedia presentation portions are displayed simultaneously with interactive potions;
permitting a plurality of group leaders to register for access to training programs;
providing different subscription options based upon one of a number of training programs available to a group leader, an amount of time a group leader has access to the training programs, and a number of individuals a group leader is permitted to assign to a learning group;
permitting a group leader to create learning groups consistent with a subscription level of the group leader by assigning individuals to learning groups;
permitting individuals within a learning group to provide comments to the interactive portion of a training program; and
permitting individuals to set customized and personal criteria for display of interactive portions such that the interactive portions are filtered according to personal preferences of the individuals within the learning group.

36. The method of claim 35 wherein the training programs comprise a sequence of lessons, each lesson comprising a multimedia presentation portion and an interactive portion, and further comprising:
permitting individuals to access lessons out of order.

37. The method of claim 35 wherein multiple group leaders are associated with a common client and further comprising:
permitting identification of a client representative who is given access the interactive portion of each training program, and wherein the access by the client representative is hidden from the individuals within the learning group.

38. The method of claim 35 further comprising:
permitting a group leader to create sub-groups within a lesson group wherein the interactive portion of a training program is not available to individuals outside an assigned subgroup.

39. The method of claim 36 further comprising:
providing group leaders with access to a plurality of predefined conversation starters which the group leader may select for providing to individuals of a learning group or subgroup to facility discussion within a training program.

40. The method of claim 35 further comprising:
providing group leaders with the ability to set privacy settings determining whether the interactive portion of a training program will be accessible beyond a designated learning group.
